(19) United States
(12) Patent Application Publication
(10) Pub. No.: US 2008/0195527 A1
(43) Pub. Date: Aug. 14, 2008

(54) Method and Apparatus for the Lending of Monetary Funds While Taking Collectibles as Collateral

(75) Inventors: Anthony G. Barreiro, San Francisco, CA (US); Ernest Ray Parker Gaylord, San Francisco, CA (US); Eric C. Kjome, San Francisco, CA (US); Timothy Conway, Los Altos, CA (US); Steve McVay, Campbell, CA (US)

Correspondence Address: WHITE & CASE LLP;PATENT DEPARTMENT, 1155 AVENUE OF THE AMERICAS, NEW YORK, NY, 10036, US

(73) Assignee: ARTLOAN FINANCIAL SERVICES, LLC, San Francisco, CA (US)

(21) Appl. No.: 11/674,644

(22) Filed: Feb. 13, 2007

(51) Int. Cl. G06Q 40/00

(52) U.S. Cl. 705/38

(57) ABSTRACT

A method and system of exchanging collectibles for a loan of money allows an Applicant to remotely apply for and receive funds in exchange for works of art and other collectibles. An Applicant specifies the loan sought and submits personal and collateral information. Thereafter, the form and information are analyzed and a loan amount is determined. The Applicant transfers the collectible to the Lender over a delivery channel. Upon final approval of the loan, the Lender transfers funds to the Applicant. A similar process may be undertaken for items at auction. Auction lots are pre-approved by Lender. If an Applicant wins the auction lot, the Applicant pays a Residual Amount on the item. The Lender pays the remainder of the auction price. In either situation, the Applicant may pay off the loan in four months for return of the collectible or may renew the loan.

### BACKGROUND OF THE INVENTION

A) Field of the Invention

This invention relates to a method and apparatus for lending money, taking collectibles as collateral. More particularly, the present invention relates to a method of lending money while taking collectibles as collateral, where the amount of money that is dependent upon the estimated value of the collectibles.

B) Description of the Related Art

Business and individuals engage in the business or hobby of collecting art, antiquities and other collectibles such as photographs, books, manuscripts, jewelry, wine, cigars, and the like. Items of this description have value derived from their age, design, condition, desirability, history, manufacturer, ownership and/or rarity. Auction houses such as Sotheby's, Christie's and Bonhams & Butterfields auction off billions of dollars worth of collectibles each year.

Purchasers of art, antiquities and other collectibles acquire these items for both aesthetics and investment. Those in the market of buying and selling art/collectibles for investment may accumulate large inventories of collectibles, each item stored until the proper market conditions arise that allow a profitable sale.

In some instances, an individual or entity engaged in such a business or hobby needs a loan to obtain a collectible. However, in most instances, banks and other lending institutions are only willing to allow borrowers to use real property as collateral for the loan. Art galleries with millions of dollars worth of inventory, therefore, may be unable to obtain a loan because it cannot use their inventory as loan collateral.

Traditionally, pawnbrokers will allow a person to obtain a short-term loan in exchange for an item of value. Within a prescribed period of time, the person pawning the item may redeem it for the amount of the loan plus fees and interest. If the prescribed loan duration elapses without payment, the pawnbroker becomes legally vested in the item and may sell the item if so desired.

However, traditional pawnbrokers have a limited amount of money they are willing to lend, even on an item of high value. This amount of money is typically small, usually on the order of $5,000. Pawnbrokers are not specially trained to appraise or assess the value of art, antiquities or collectibles and do not typically lend on such items. To an art collector or dealer who has collectibles valued at hundreds of thousands of dollars or more, such a small loan is not useful.

In addition, most pawnbrokers operate out of a store front which functions as the site where items are initially brought in by the client, appraised, stored, and later resold. Pawnbrokers typically do not employ adequate security measures for protecting collectibles of high value, and typically do not have enough space to store oversized collectibles (such as large paintings, sculptures, or pieces of furniture). Moreover, pawnbrokers do not provide or facilitate transportation arrangements for their clientele. A client must bring its item into the store front pawnbroker for appraisal.

In situations where a collectible comes up for auction, depending on the desirability of the item, it may be very important to a collector (or dealer) to obtain that particular item to increase their collection or inventory.

However, the collector or gallery may not have the funds necessary to purchase the item at the time. In order to avoid losing the opportunity, it would be desirable to allow one to obtain a loan to purchase the item at an auction, collateralized by the auction item itself or by collectible personal property.

It is desirable to have a method that allows one to obtain monetary funds in exchange for art/collectibles. It is also desirable to have a system that facilitates such an exchange.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding purposes only.

FIGS. 1A-1B is a flowchart illustrating the steps undertaken to process an Equity Loan;

FIG. 2 is a flowchart illustrating the steps undertaken to calculate a Core Liquidation Value;

FIG. 3 is a flowchart illustrating the steps undertaken to process an Auction Loan;

FIG. 4 is a flowchart illustrating the steps undertaken to utilize the services of a Notary Public;

FIG. 5 is a block diagram illustrating the components of a system of the present invention;

FIG. 6 is a flowchart illustrating the steps undertaken to process a loan pay off;

FIG. 7 is a flowchart illustrating the steps undertaken to process a loan renewal; and

FIG. 8 is a flowchart illustrating the operation of an Inventory Management module of the present invention.

### DETAILED DESCRIPTION

In the following description, for purposes of explanation, numerous specific details are set forth to provide a thorough understanding of the present invention. However, it will be apparent to one skilled in the art that these specific details may not be required to practice the present invention. In other instances, well-known structures and devices are depicted in block diagram form to avoid unnecessary obscuring of the invention. In the following description of the embodiments, substantially the same parts are denoted by the same reference numerals.

An embodiment of the present invention allows a loan applicant to obtain funds using collectibles as collateral from any location. An applicant electronically submits an application that includes information regarding a collectible. The lender evaluates the collectible. If qualified, the applicant ships the collectible to the lender and the lender sends the loan proceeds to the applicant. Because of the value of the collectible, a credit check is not required, thus keeping the transaction private.

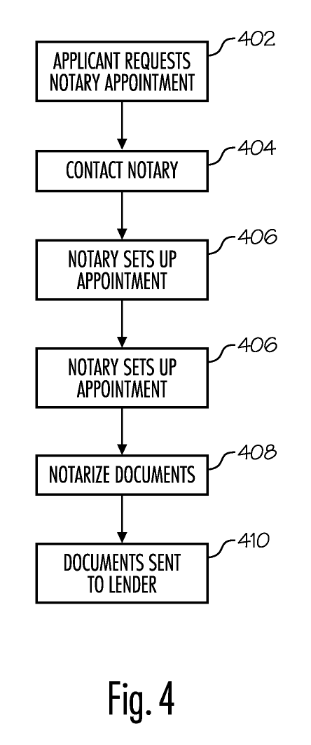

An overview of the system used to accomplish the present invention is illustrated in FIG. 5. An embodiment of the present invention contains a variety of different modules each connected to each other via the Internet 502. The modules may include a module 504 configured to handle shipping requirements, a module 506 for use by an auction house, a loan maintenance module 508, a client portal module 510, an inventory module 512, a notary module 514, and a valuation database module 516. The modules may operate on any type of computer system currently known or developed in the future. An exemplary current computer system includes an input device such as a keyboard, a display device such as a monitor, a processor, and memory. Such a computer may be connected to the Internet in a variety of different ways, including via a cable modem, a DSL connection, a dial-up connection, a T1 line, or any other wired or wireless connection. As is well known in the art, the Internet facilitates communication between computer systems that need not be located near each other. As such, the modules listed in FIG. 5 may be accessed by users in separate and distant locales. In an exemplary embodiment, the various modules are stored on a web server and accessed via an Internet browser. Although the present invention is described herein with reference to the Internet, it will be evident to one skilled in the art that any suitable network that is capable of communicating digital information from one place to another, whether wired or wireless, may be employed.

The modules described above may take many forms and may be implemented in many different ways. A module may be a distinct set of hardware, firmware, and software dedicated to perform a certain task. Alternatively, a module may be a section of computer code within a larger set of code. The modules may also comprise web pages that allow data entry, data viewing, and data transmission. Various modules may be located within a single computer system or they may be located in distinct, distant places. The modules may execute on any type of computer system currently known or developed in the future. The computer system typically includes a main memory, such as a random access memory (RAM) or other memory device, a bus, a non-volatile memory such as a hard disk and a processor for executing instructions.

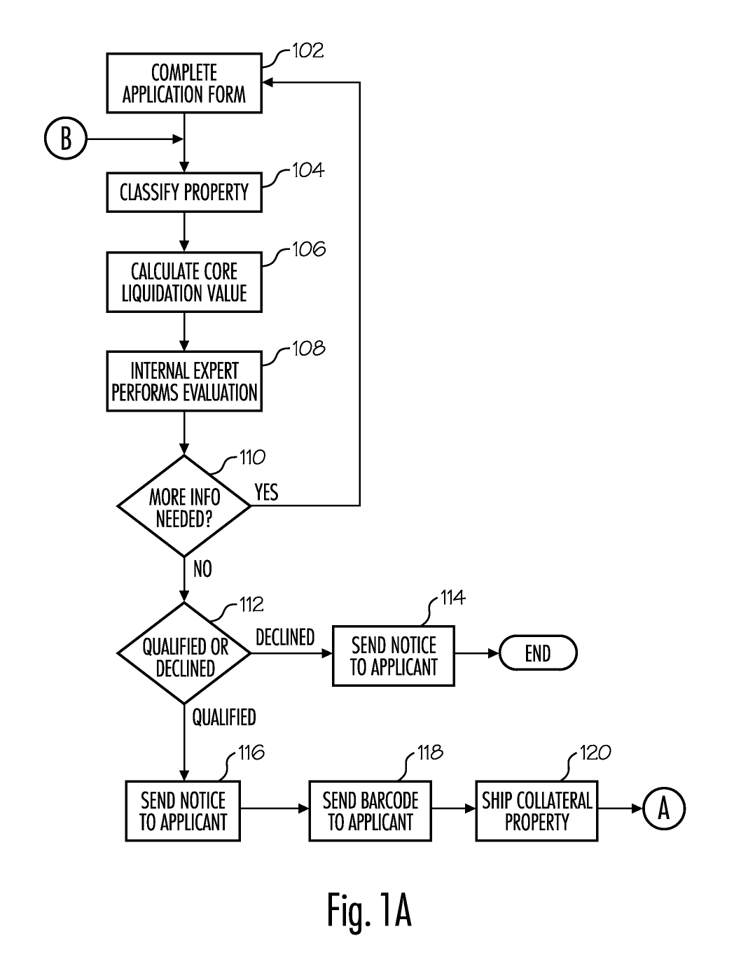

With reference to FIGS. 1A-1B, a flowchart illustrating the operation of an embodiment of the present invention is shown. At step 102, an applicant for a loan completes an electronic application form and submits the application to the lender for loan approval. The applicant may access and complete the electronic application form via client portal module 510. The applicant enters his or her personal information, such as name, address, e-mail address, etc. as well as information related to the collectible to be used as collateral (hereafter the “Collateral Property”). The collected information may include an identification of the Collateral Property; the type of Collateral Property (e.g., painting, photograph, antique, coins, stamps, furniture, etc.); one or more photographs of the Collateral Property; a condition report regarding the Collateral Property; a description of how the Collateral Property was obtained; and documentation related to the chain of ownership.

At step 104, each piece of Collateral Property is classified according to it's attributes and a classification code is assigned to the Collateral Property. The classification code may take a variety of different forms. In one embodiment, the classification code is hierarchical in nature. It is first determined to which major division the Collateral Property belongs. The major division may include, for example, fine art and decorative art. The major division of fine art may be divided by type of work (e.g., sculpture or painting). Within the painting division, there may be a sub division based on type of painting (e.g., watercolor or oil). Further subdivisions may include time period of creation, country of the artist, size of the work, and the like. Similarly, within the decorative arts category, there may be a division for furniture, clocks. Subdivisions may include time period of creation, country of origin, and the like. Further subdivisions can be made to include as much or as little detail as desired.

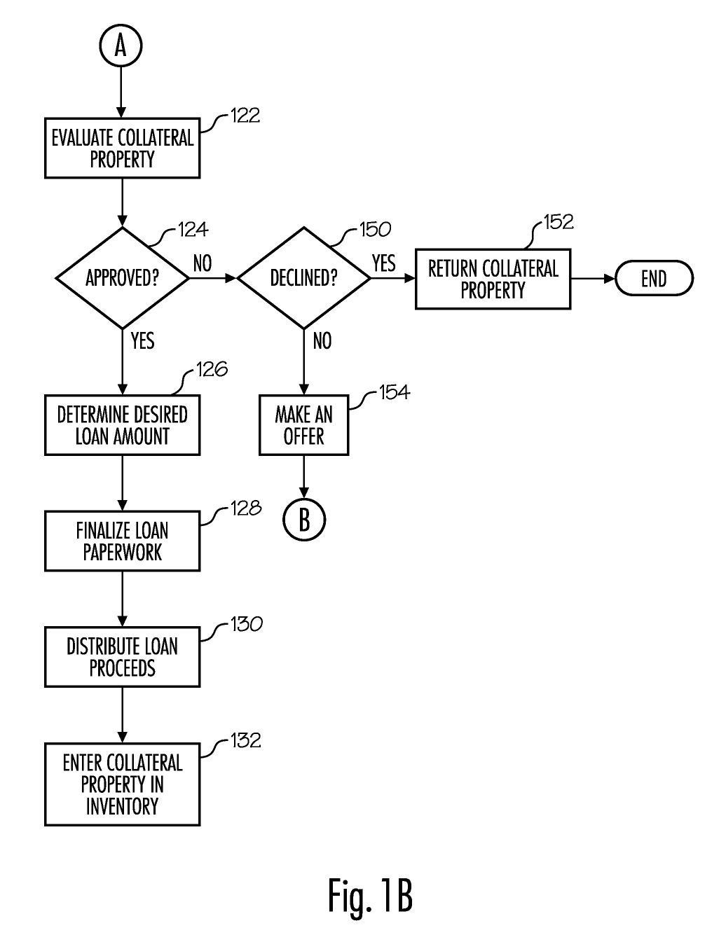

At step 106, a Core Liquidation Value (“CLV”) is calculated and assigned to the Collateral Property. The details of how the Core Liquidation Value is calculated are explained in further detail below with respect to FIG. 2.

At step 108, one or more Trained Persons evaluates the application information. A Trained Person is a person who works with a lender and has particular expertise (either through training or experience) in evaluating the Collateral Property. A Trained Person may be located anywhere in the world with an Internet connection. The Trained Person uses a system of the present invention to view the Application, pictures of the Collateral Property, and other relevant information used to calculate the CLV. The Trained Person reviews all the information and presents his or her opinion as to the value of the Collateral Property and whether or not the Application should be approved.

At step 110, the application is reviewed to determine if more information is needed. The applicant submits additional information in step 102 if required. Steps 104 to 108 are repeated until a status of “declined” or “qualified” is earned, as described below.

At step 112, the application is given a status of either “qualified” or “declined.” A status of “declined” means that the Collateral Property is not of enough value to be collateral for obtaining a loan. There may be a variety of different reasons for declining an application. For example, the market demand for the Collateral Property may be deemed low, the Collateral Property may be in poor condition, the Collateral Property may not be authentic or the applicant may be unable to establish a valid claim of ownership. An application deemed to be an attempt at fraud is also declined. If the Applicant cannot sufficiently prove ownership or the method in which he obtained the Collateral Property, the application may be declined. An application may also be declined if there is not enough information regarding the Collateral Property. If the Collateral Property is deemed to not have sufficient value, it may be declined. In one embodiment, the Collateral Property must have a core liquidation value of at least $10,000 to qualify. There may be various other reasons that an application may be declined.

At step 114, a system of the present invention sends notification to the applicant that the application has been declined. A status of “qualified” means that the Collateral Property is approved for further processing and the application proceeds to step 116.

At step 116, the applicant is notified of the approval of the application and provided with information needed to ship the Collateral Property to the lender over a delivery channel. In one embodiment, the applicant is responsible for paying for the shipping. The applicant is provided with a list of approved shippers. The applicant is also provided with a unique identifier that is associated with the Collateral Property (step 118). The unique identifier may be a bar code of any form (e.g., one-dimensional, two-dimensional, etc.), a radio frequency identification (RFID) tag, and the like. The applicant attaches the unique identifier to the Collateral Property and arranges to ship the Collateral Property. The Collateral Property is packaged and shipped to a location predetermined by the lender (step 120). In this manner, the shipping of the Collateral Property can be tracked using whatever method the shipper has of tracking packages. Thereafter, a system of the present invention associates the shipping information with the Collateral Property.

Once the lender receives the Collateral Property, it is evaluated to determine its authenticity and if a loan should be made on the Collateral Property (step 122). This evaluation may be performed by a Trained Person. There are several possible outcomes of this evaluation. The Collateral Property may be designated as “declined,” “pending,” or “approved.”

Collateral Property may be designated “declined” if it is determined that the Collateral Property is of insufficient value to provide a loan. (Step 150). In this case, the applicant is notified and the property is returned to the Applicant. (Step 152). In some embodiments, the applicant had pre-paid for return shipping when it shipped the item to the lender. In that case, the item is returned to the applicant using the pre-paid shipping label.

If the Collateral Property is assigned a status of “pending,” additional information is needed. The lender contacts the applicant or Trained Person to obtain the additional information. Processing continues at step 104.

In some cases, an alternate offer may be made on the Collateral Property. If the Trained Person assesses the Collateral Property at a value less or more than the originally quoted value, an Alternate Offer is made.

If the Collateral Property is assigned a status of “approved,” the lender is willing to offer the loan in the qualification stage. Operation continues at step 126, the applicant is queried as to the loan amount desired. Typically, the loan is approved for approximately 50 to 75% of the estimated value of the Collateral Property. The Applicant may request a loan amount up to the approved limit. There may also be a lower limit in which the Applicant is required to make a loan of at least a certain amount of money. In one embodiment, the lower limit is $10,000.

At step 128, the final loan paperwork is finalized. This may involve the paperwork being notarized and executed by the applicant. The executed and notarized documents are transmitted to the lender in any one of a variety of different methods, including via Fax, e-mail, first-class mail, or via overnight courier. At step 130, the loan proceeds are transmitted to the applicant in one of a variety of different transfer methods, such as via cashier's check or via bank wire.

At step 132, the Collateral Property is entered into inventory and its exact location is recorded in a database based on the item's bar code. The lender stores the Collateral Property until the Applicant either repays the loan amount or defaults on the loan.

In one embodiment, the distribution of the loan proceeds (step 130) may be delayed, at the option of the Applicant. The Applicant is approved for a loan of up to a certain amount of money in step 126. But the Applicant may choose not to receive any loan proceeds until a later time. The Applicant may have various reasons to defer receipt of the loan proceeds. The Applicant may want to use an embodiment of the present invention in a manner akin to a line of credit. The Applicant would be allowing the Lender to store his collectibles in exchange for the ability to obtain the funds at a later time. The Applicant pays interest only on the funds actually received from the line of credit.

In a similar manner, a collector or gallery could send multiple unwanted collectibles to the Lender over a period of time in order to accumulate potential funds. Thus, when the collector has a need for the money (for example, the collector has found another collectible he wishes to purchase) he uses Client Portal 510 to request the distribution of funds.

FIG. 2 illustrates the steps for calculating a Core Liquidation Value or CLV. As described above, the Core Liquidation Value is an estimate of the value at which the Collateral Property can be immediately liquidated. A system of the present invention monitors timely auction results of prescribed auction houses. Each auction item sold is categorized using the Classification Code described above. The Classification Code and other information regarding the Collateral Property, such as the estimated selling price, the actual selling price, detailed information identifying the item, the number of times the item has sold, and the length of time between the date the item was first put up for auction and the date sold, is stored in a Valuation Database.

At step 202, the Valuation Database is queried to calculate a typical selling price for similar Collateral Property. Other queries are performed to calculate the typical time interval between the date offered and date sold (step 204) and to calculate the number of times the item was offered for sale (step 206). The queries can be performed in any one of a variety of ways to perform database queries, now known or developed in the future. At step 208, the data obtained in steps 202 through 206 is combined to determine the Core Liquidation Value.

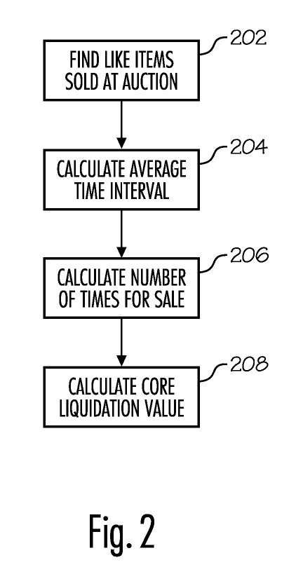

Another embodiment of the present invention is illustrated in FIG. 3. An applicant may wish to purchase an item that is available at auction or at a retail gallery. As mentioned above, there are times when an applicant has a desire to acquire a particular item or items available at auction but lacks the necessary funds to do so. Because of the uniqueness of the item, the opportunity for acquisition is limited. Therefore, the applicant may seek a loan to purchase the item while it is still available at auction.

At step 302, the lender examines lots at auction at an pre-determined auction house. Lots that meet the Lender's criteria are pre-approved for a loan amount and advertised as such. In one embodiment, the Lender may maintain a website that lists the pre-approved auction houses and auction lots. The website may include an image and description of the lot, estimated sale price range, the maximum the lender is willing to lend, the interest rate to be charged, and the residual amount an applicant would have to fund. The criteria used by the lender to determine whether or not an auction lot is eligible is based partly on the Core Liquidation Value, described above with respect to FIG. 2.

At step 304, an Applicant fills out an application using an on-line form. Because the lot is pre-approved, it is not necessary to further evaluate the items in the auction. The applicant needs only to enter personal information, such as name and contact information. At step 306, the applicant bids on the lot at auction. In one embodiment, the lender has no involvement in the bidding process. All bids are made directly through the auction house in the manner prescribed by the auction house (e.g., live or via the Internet). If the applicant fails to secure the item (step 308), the lending process ends. If the applicant wins the item, then, at step 310, the data from the invoice, including the final sale price and all fees, is entered into a system of the present invention. In one embodiment, the auction house transmits the invoice information directly to the lender. In another embodiment, the applicant sends the invoice information to the lender, for example via the website maintained by the lender.

At step 312, a Notice of Winning Bidder's Instructions and Auctioneer's Demand (NOWBI) is presented to the applicant by lender. The NOWBI contains information needed to complete the process. The Applicant signs and agrees to the terms of the NOWBI and returns to Lender. The Applicant pays the Residual Amount directly to the auction house. In one embodiment, a module in the present invention allows an Applicant to transfer funds directly to the auction house or retail gallery. Typically, the Residual Amount is the amount not covered by the loan. For example, an Applicant may receive a $75,000 loan or a 75% loan-to-value ratio on an item that sold for $100,000. The Applicant would be required to pay the difference between the auction price (and associated fees) and the loan amount (the difference being $25,000 in this hypothetical).

At step 314, the lender forwards the applicant's signed NOWBI to the auction house. The auction house verifies the sale price and the receipt of the Residual Amount. The auction house also agrees to release the auction item directly to the Lender once transfer of final payment is received. The auction house signs the NOWBI and returns it to the Lender (step 316). The NOWBI can be returned to the Lender in a variety of different ways. The NOWBI may be hand delivered. In the alternative, the NOWBI may be transferred electronically, in which case the data is forwarded to the Lender via a computer network such as the Internet. In another embodiment, the NOWBI is scanned into a common, predetermined format (such as JPG or PDF) and electronically transmitted to the Lender. This transmission may be via HTTP, FTP, email, or any other type of format now known or developed in the future for transmitting scanned documents. In another embodiment, the NOWBI is faxed to the lender. In embodiments where the NOWBI is scanned or faxed, the NOWBI may have a unique identifier (such as a bar code), to facilitate data entry and uniquely and efficiently identify the transaction.

Once the Lender receives all the applicable documents, a contract is sent to the Applicant (step 318). Once the Applicant signs the contract and has it notarized, the loan proceeds can be distributed to the auction house (step 320). This process may be automated. For example, once the NOWBI and notarized documents are received, the associated bar codes or unique identifiers may be scanned in. Once the system receives notification that all necessary documents have been received, the funds are released to the auction house. In one embodiment, the funds are electronically wired to the auction house, using information provided by the auction house to correctly transfer the funds to the appropriate account. In another embodiment, a check may be automatically printed. The appropriate mailing documents may be automatically generated. Thereafter, the printed check is sent to the auction house, using the automatically generated mailing documents.

Once the auction house receives the funds from the Lender, the auction house prepares the purchased auction lot, or Collateral Property, for shipment to the Lender. The Lender then uses a shipping agent to ship the Collateral Property to a storage facility operated by the Lender. Once the Collateral Property arrives at the storage facility, it is entered into inventory, where its location can be tracked in a database contained in an embodiment of the present invention.

In one embodiment of the present invention, the loan is for a short period of time, typically four months. At the end of the four month period, the Applicant has several alternatives. Applicant may pay off the loan, may extend the term of the loan, or may default on the loan.

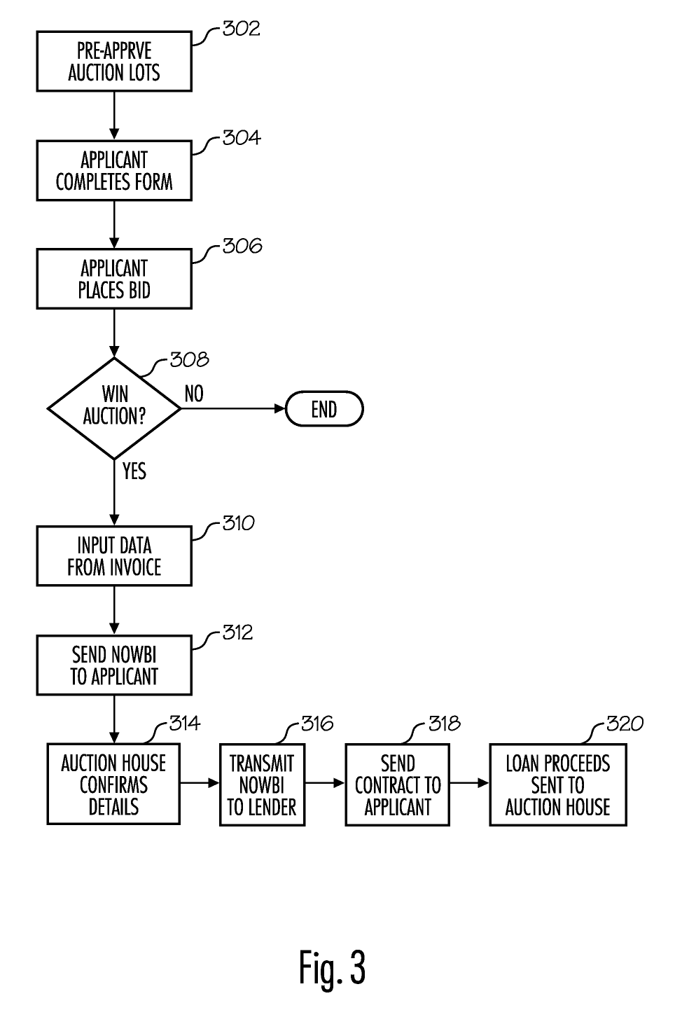

In some embodiments, the lender may require that the NOWBI or other loan documents be notarized. In such a situation, an automated process may be present to allow the applicant to obtain the notarization at a minimum of inconvenience to the applicant. Such a process is illustrated in FIG. 4. Once the lender receives a NOWBI, the applicant requests an appointment with a notary (step 402). This request may be made by accessing the notary module 514 through the use of a web browser. The applicant confirms the address to which the Notary should go. Thereafter, the notary is contacted (step 404). This may occur in a variety of different ways. In one embodiment, an e-mail is sent to the notary. It should be understood that other notification methods are possible. For example, a text message or an instant message could be sent to the notary. This contact may be automated or be performed by a person. In another embodiment, a third party (a “signing service”) is contacted by one of a variety of different methods. The signing service may maintain a list of notaries that it works with. The signing service selects a notary. At step 406, the notary contacts the applicant (preferably within 48 hours) and arranges a time and location for the notary services to be performed. The notary may input the time and place for the notary services in Notary Module 514. The notary obtains a copy of the contract or document to be notarized from Notary Module 514. Typically, the notary is able to access and print a scanned version of the paper to be signed. At step 408, the notary meets with the applicant and completes the notary process. The notary then faxes a copy of the notarized document to the Lender and also sends a hard copy of the notarized to the Lender. (Step 410).

Thereafter, the signed and notarized document is transmitted to the lender. As above, the transmission may be in any one of a variety of different methods. For example, the transmission may be via mail, e-mail, fax, or overnight delivery service.

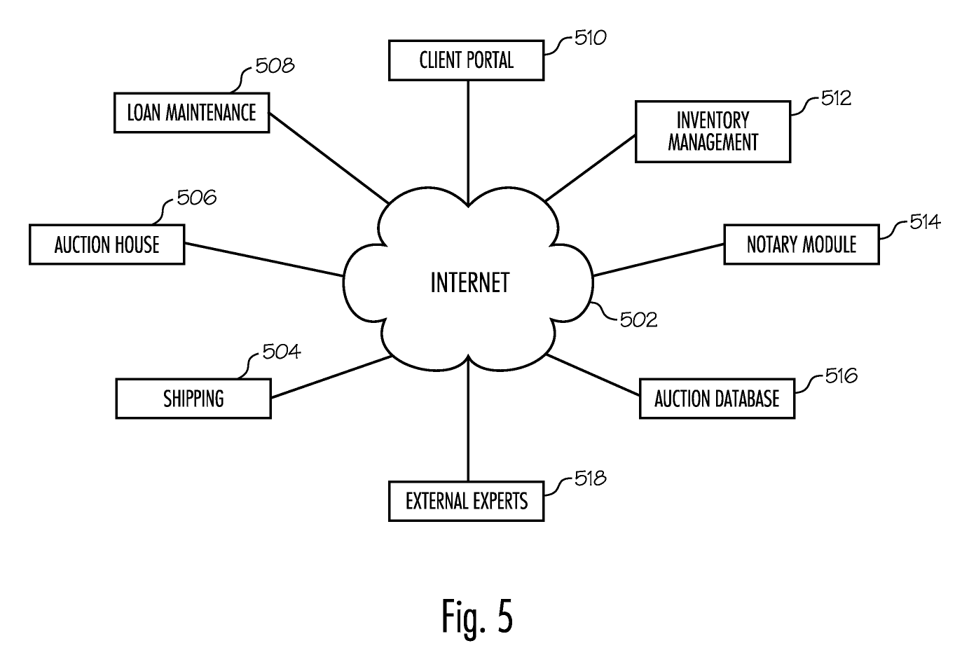

With respect to FIG. 6, the process for paying off a loan is illustrated. It should be understood that this process is applicable for both the Equity Loan illustrated in FIGS. 1A-1B and for the Auction Loan illustrated in FIG. 3. At step 602, the applicant submits a payment to the lender. The payment is comprised of the loan amount plus interest and fees. The Applicant may make a payment in a variety of different ways. For example, the Applicant may input information with respect to his bank account, including a routing number and account number. Thereafter, the information is used to create a check which is then presented at the bank for payment. In the alternative, the Applicant may wire money to the lender using an automated clearing house (ACH) transaction. The applicant may send a check to the lender prior to the expiration or pay off date of the loan. The applicant may arrange to meet a representative of the lender at a bank or other financial institution, to carry out the transaction in person.

At step 604, after the payment is verified, the Lender schedules a pickup of the Collateral Property. This process may be accomplished by creating a webpage with a data entry section. The Applicant accesses the data entry section and selects the best manner for picking up the Collateral Property. For example, the applicant may elect to have the lender return the Collateral Property using the same (or similar) shipping method as used to deliver the Collateral Property to the lender. The applicant may elect to make alternative arrangements to pick up the Collateral Property at the storage facility. In such an instance, the applicant will input a desired time and place to conduct the exchange.

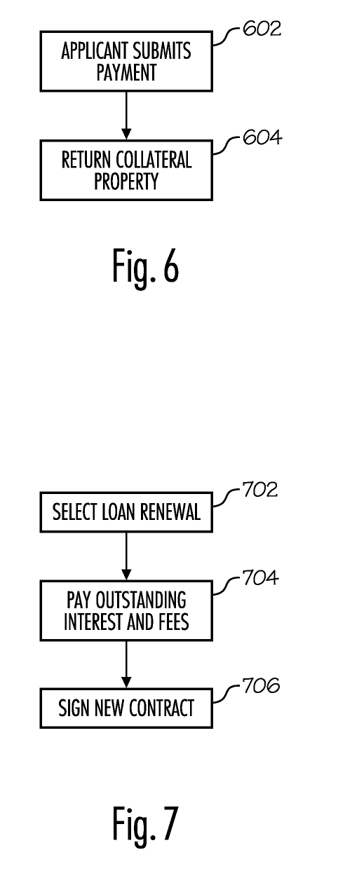

With respect to FIG. 7, the process for renewing the loan is illustrated. It should be understood that this process is applicable for both the Equity Loan illustrated in FIGS. 1A-1B and for the Auction Loan illustrated in FIG. 3. At step 702, the applicant indicates his or her desire to renew the loan. This process is typically accomplished by the applicant accessing a webpage and selecting the appropriate option. At step 704, the applicant pays all outstanding interest and fees due on the loan at that time. The full payment of the loan is then deferred for up to four additional months.

In the event that an applicant defaults on a loan, the lender makes an entry into the database noting the default. Thereafter, the Collateral Property belongs to the lender. The lender may desire to sell the Collateral Property to recoup the loan expenses incurred. In the alternative, the lender may desire to hold the property for a period of time if the lender decides that the Collateral Property may increase in value in the next few months or years.

An embodiment of the present invention also handles inventory management. As discussed above, Collateral Property, comprising art and other collectibles, is sent to the Lender in exchange for monetary funds. With many Applicants sending Collateral Property to the Lender, there must be a method and system to track the Collateral Property. As discussed above, each item of Collateral Property is assigned a unique identifier (such as a bar code), which is then attached to the shipping container. When the Collateral Property is received by the Lender, the unique identifier is scanned. An Inventory Database maintains a record of each item of Collateral Property that is received. The data being tracked may include identification data for the Collateral Property (e.g., name of the piece, type of Property, value, etc.). Linked to the identification data is applicant information for each item (e.g., name and contact information). In addition, item location information is also stored in the database. The Lender may use any number of a variety of methods to track the location information. For example, the Lender may have multiple secured facilities. Therefore, the name of the secured facility would be stored in the database. In addition, locations within the secured facility may also be stored in the database. Location information may include indicia such as a shelf location. In one embodiment, each shelf in a secure facility may have a unique identifier assigned to it. Therefore, when Collateral Property is placed on a shelf, the unique identifier for the Collateral Property is scanned along with the unique identifier for the shelf. In such a manner, the location of each item of Collateral Property is located in the Inventory Database.

Each time an item is moved, the movement of the item is also tracked in the Inventory Database. For example, if an item is moved from one shelf to another shelf, the new shelf unique identifier may be read and associated with the item of Collateral Property.

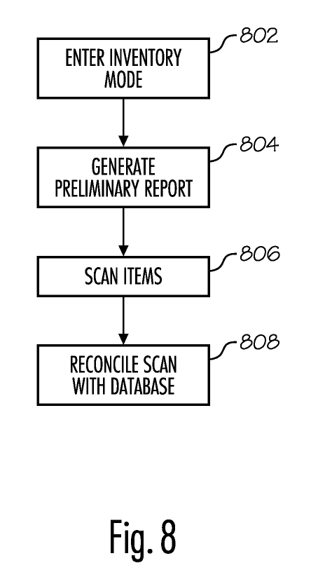

Periodically, an inventory report may be run. With reference to FIG. 8, the steps undertaken to create an inventory report are illustrated. It should be understood that this process is applicable for both the Equity Loan illustrated in FIGS. 1A-1B and for the Auction Loan illustrated in FIG. 3. If the unique identifier is in the form of a bar code, the inventory report would be undertaken using a hand-held bar code scanner that is in communication with the Inventory Database. At step 802, an inventory mode is entered. There are several different modes of operation for the hand-held bar code scanner. As mentioned above, each time an item is moved, it can be tracked via the bar code scanner. An inventory mode indicates to the system that it is merely entering data in to determine the current position, as opposed to showing a change of position. At step 804, a preliminary inventory report is created. The report shows a list of all Collateral Property in inventory and its location information. The report can be created in any one of a number of different ways. For example, a series of structured query language (SQL) statements can be used to obtain the list of records. Thereafter, a report generating program can be used to generate the report.

At step 806, a user manually walks through the secure facility and scans the unique identifier of each item, along with a unique identifier indicating the location. As each item is scanned, the results of the scan are stored in the Inventory Database. At step 808, the results of the step 806 are compared to the previous contents of the Inventory Database and the information is reconciled. Old information regarding the location is noted in the Inventory Database. In one embodiment, a report is generated noting the discrepancies between the previous contents of the Inventory Database and the results of step 806. Such a report may be useful in determining movements of items that were not properly logged.

In the foregoing specification, the invention has been described as applicable to an implementation anticipating Internet based application process and mail or other long-distance delivery of the Collateral Property, where the special advantages of the method are very attractive. However, the same invention may be applied in other settings in which art and other collectibles are exchanged for loan proceeds.

In the forgoing specification, the invention has been described with reference to specific embodiments thereof. However, various modifications and changes may be made thereto without departing from the broader spirit and scope of the invention. The specification and drawings are, accordingly, to be regarded in an illustrative sense rather than a restrictive sense. In fact, it will be evident to one skilled in the art that modifications and variations may be made without departing from the spirit and scope of the invention. Although specific terms have been employed, they are intended in a generic and descriptive sense only and not for the purpose of limitation, the scope of the invention being delineated in the claims that follow. Although the invention has been described with respect to artwork and other collectibles, it should be understood that embodiments of this invention can be used for any type of tangible item (i.e., all forms of property except real estate).

What is claimed is:

1. A method for lending money, using a collectible as collateral, comprising:
receiving an electronic application from an applicant via a computer communications network, including information identifying the applicant and information about a collectible;
calculating the estimated liquidated value of the collectible;
receiving the collectible;
approving the loan; and
paying loan proceeds to the applicant.

2. The method of claim 1 wherein said collectible comprises artwork, antiquities, or other item which derives value through age, design, condition, desirability, history, manufacturer, ownership and/or rarity.

3. The method of claim 1 further comprising:
storing said collectible in a secure storage facility.

4. The method of claim 1 wherein said step of receiving the collectible comprises:
sending shipping and tracking information to the applicant;
requesting that the applicant send said collectible via a shipping agent;
receiving said collectible from said shipping agent.

5. The method of claim 1 wherein said step of calculating said estimated liquidated value comprises:
querying a valuation database to find similar item(s);/
determining a typical price for said similar item(s);
determining a typical number of times said similar item(s) have been offered at auction;
determining a typical time interval between the offer and sale of said similar item(s); and
determining said estimated value based at least in part on said typical price, said typical number of times similar item(s) have been offered at auction, and said typical time interval between the offer and sale of similar item(s).

6. The method of claim 1 further comprising:
evaluating the collectible by a trained person; and
using said evaluation in calculating an estimated value.

7. The method of claim 1 wherein:
said loan matures in a period of no more than four months.

8. The method of 7 wherein:
upon the payment of the loan interest and fees, said loan is extended for an additional period of no more than four months.

9. The method of claim 1 further comprising:
returning said collectible to the applicant upon the repayment of the loan.

10. The method of claim 3 further comprising:
assigning a unique identifier to the collectible for tracking its location.

11. The method of claim 10 wherein:
the unique identifier is a barcode.

12. The method of claim 10 wherein:
the unique identifier is a radio frequency identifier.

13. A method for lending money, using collectibles at auction for collateral, comprising:
pre-approving for lending against one or more auction lots at an auction house;
receiving an application from an applicant indicating a pre-approved lot;
if the applicant wins the pre-approved lot, confirming the sales price and fees of the pre-approved lot;
confirming payment of the residual amount by applicant;
paying loan proceeds to the auction house in satisfaction of the lot balance; and
receiving the pre-approved lot.

14. The method of claim 13 wherein:
said application is available in an electronic format; and
wherein said application is transmitted from the applicant to the lender via the Internet.

15. The method of claim 13 further comprising:
obtaining invoice data from the auction house or applicant; and
confirming the sales price and fees of the pre-approved lot.

16. The method of claim 13 further comprising:
obtaining notarized loan documents from said applicant.

17. The method of claim 16 wherein said obtaining step further comprises:
querying a database to locate a notary public near the applicant;
contacting said notary public; and
arranging notarization of said loan documents.

18. A system for loaning money in exchange for a collectible comprising:
a computer that is coupled to a telecommunications network;
one or more sequences of computer program instructions which, when executed, cause the computer to perform the steps of:
receiving an electronic application from an applicant via the Internet,
including identification information and information about a collectible;
determining the estimated value of the collectible;
physically receiving the collectible;
approving the loan; and
paying loan proceeds to Applicant.

19. A system for loaning money in exchange for a collectible comprising:
a computer that is coupled to a telecommunications network;
one or more sequences of computer program instructions which, when executed, cause the computer to perform the steps of:
pre-approving for lending one or more auction lots at an auction house;
receiving an application from an applicant indicating a pre-approved lot;
confirming the sales price and fees of the pre-approved lot, in the event that the applicant wins the pre-approved lot;
confirming payment of the residual amount by applicant;
paying loan proceeds to the auction house in satisfaction of the lot balance; and
receiving the pre-approved lot.

20. A computer program product comprising:
a computer readable medium containing instructions for performing the following steps:
receiving an electronic application from an applicant via a computer communications network, including identification information and information about a collectible;
calculating the estimated value of the collectible;
approving the loan; and
paying loan proceeds to applicant.

21. A computer program product comprising:
a computer readable medium containing instructions for performing the following steps:
pre-approving for lending one or more auction lots at an auction house;
receiving an application from an applicant indicating a pre-approved lot;
confirming the sales price and fees of the pre-approved lot in the event that the applicant wins the pre-approved lot;
confirming payment of the residual amount by applicant;
paying loan proceeds to the auction house in satisfaction of the lot balance; and
arranging the receipt of the pre-approved lot.
